(19) United States
(12) Patent Application Publication
(10) Pub. No.: US 2013/0235956 A1
(43) Pub. Date: Sep. 12, 2013

(54) STABILITY CONTROL IN SIGNAL DETECTION THROUGH CODE AND TIME DOMAIN CONDITIONING

(71) Applicants: Qiang Shen, San Diego, CA (US); Fuyun Ling, San Diego, CA (US); Aamod Dinkar Khandekar, San Deigo, CA (US); Sequei Anatolievich Glazko, San Diego, CA (US); Insung Kang, San Diego, CA (US); Ming Kang, San Diego, CA (US); Dario Fertonani, La Jolla, CA (US); Yuheng Huang, San Diego, CA (US)

(72) Inventors: Qiang Shen, San Diego, CA (US); Fuyun Ling, San Diego, CA (US); Aamod Dinkar Khandekar, San Deigo, CA (US); Sequei Anatolievich Glazko, San Diego, CA (US); Insung Kang, San Diego, CA (US); Ming Kang, San Diego, CA (US); Dario Fertonani, La Jolla, CA (US); Yuheng Huang, San Diego, CA (US)

(73) Assignee: QUAL COMM Incorporated, San Diego, CA (US)

(21) Appl. No.: 13/540,974

(22) Filed: Jul. 3, 2012

Related U.S. Application Data
(60) Provisional application No. 61/609,161, filed on Mar. 9, 2012.

(51) Int. Cl. H04L 25/03

(52) U.S. Cl. CPC H04L 25/0391
USPC 375/340

(57) ABSTRACT

In wireless communication systems, received signal estimation and detection is computationally intensive. During such processing, received signal matrices may be conditioned prior to inversion to improve stability. In particular, code domain conditioning, followed by time domain conditioning prior to inversion results in improved receiver performance. Such code and time domain conditioning may be particularly suited to a Time Division-Synchronous Code Division Multiple Access (TD-SCDMA) system where code values are not averaged out of a received signal matrix.

### CROSS REFERENCE TO RELATED APPLICATION

The present application claims the benefit of U.S. provisional patent application No. 61/609,161, filed on Mar. 9, 2012 in the names of SHEN et al., the disclosure of which is expressly incorporated by reference herein in its entirety.

### BACKGROUND

1. Field

Aspects of the present disclosure relate generally to wireless communication systems, and more particularly, to stability control in signal detection through code and time domain conditioning.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA), that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

According to one aspect of the present disclosure, a method for wireless communication includes stabilizing a receiving system by conditioning a matrix prior to inversion by code domain conditioning the matrix and time domain conditioning the matrix. The method may also include inverting the conditioned matrix. The method may also include calculating receiver demodulation coefficients based on the inverted matrix.

According to another aspect of the present disclosure, an apparatus for wireless communication includes means for stabilizing a receiving system by conditioning a matrix prior to inversion by code domain conditioning the matrix and time domain conditioning the matrix. The apparatus may also include means for inverting the conditioned matrix. The apparatus may also include means for calculating receiver demodulation coefficients based on the inverted matrix.

According to one aspect of the present disclosure, a computer program product for wireless communication in a wireless network includes a computer readable medium having non-transitory program code recorded thereon. The program code includes program code to stabilize a receiving system by conditioning a matrix prior to inversion by code domain conditioning the matrix and time domain conditioning the matrix. The program code also includes program code to invert the conditioned matrix. The program code also includes program code to program code to calculate receiver demodulation coefficients based on the inverted matrix.

According to one aspect of the present disclosure, an apparatus for wireless communication includes a memory and a processor(s) coupled to the memory. The processor(s) is configured to stabilize a receiving system by conditioning a matrix prior to inversion by code domain conditioning the matrix and time domain conditioning the matrix. The processor(s) is further configured to invert the conditioned matrix. The processor(s) is further configured to calculate receiver demodulation coefficients based on the inverted matrix.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 is a flow diagram illustrating stability control according to one aspect of the present disclosure.

FIG. 5 is a block diagram illustrating components for stability control according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

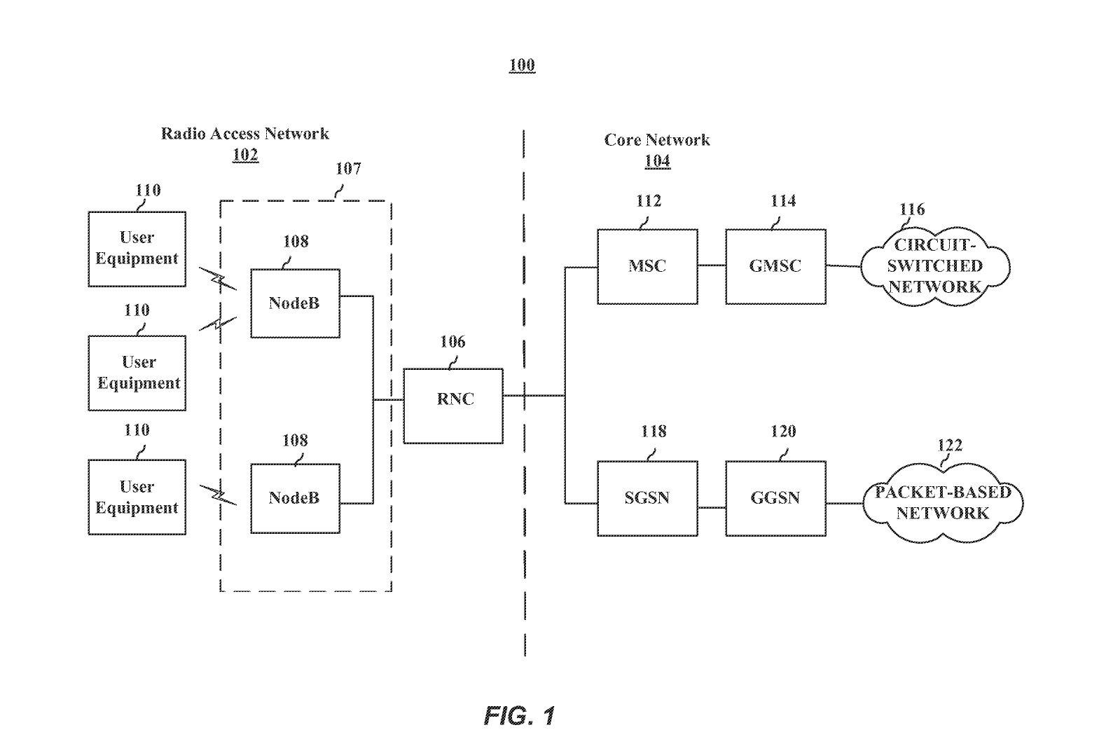

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

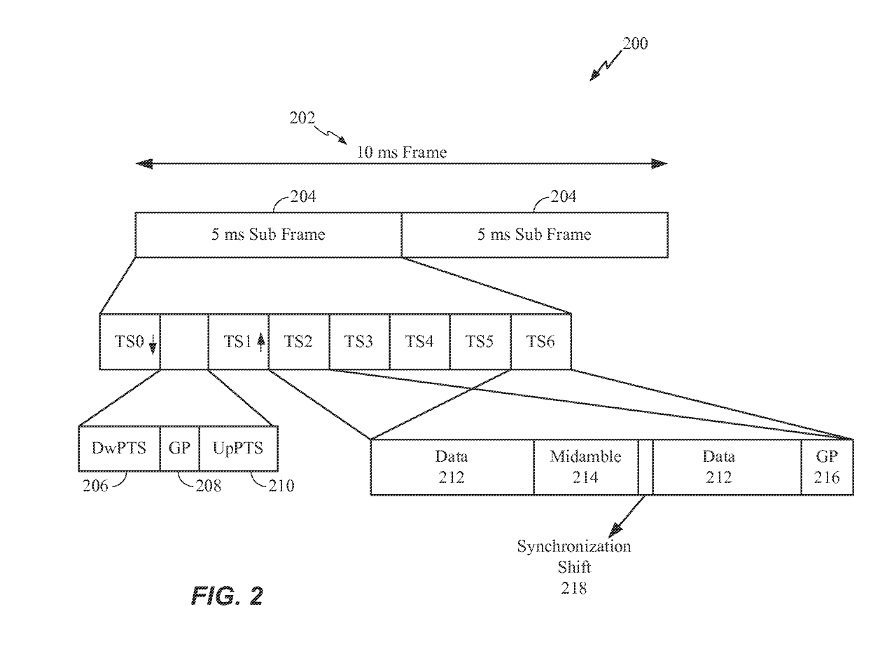

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization Shift bits 218 only appear in the second part of the data portion. The Synchronization Shift bits 218 immediately following the midamble can indicate three cases: decrease shift, increase shift, or do nothing in the upload transmit timing. The positions of the SS bits 218 are not generally used during uplink communications.

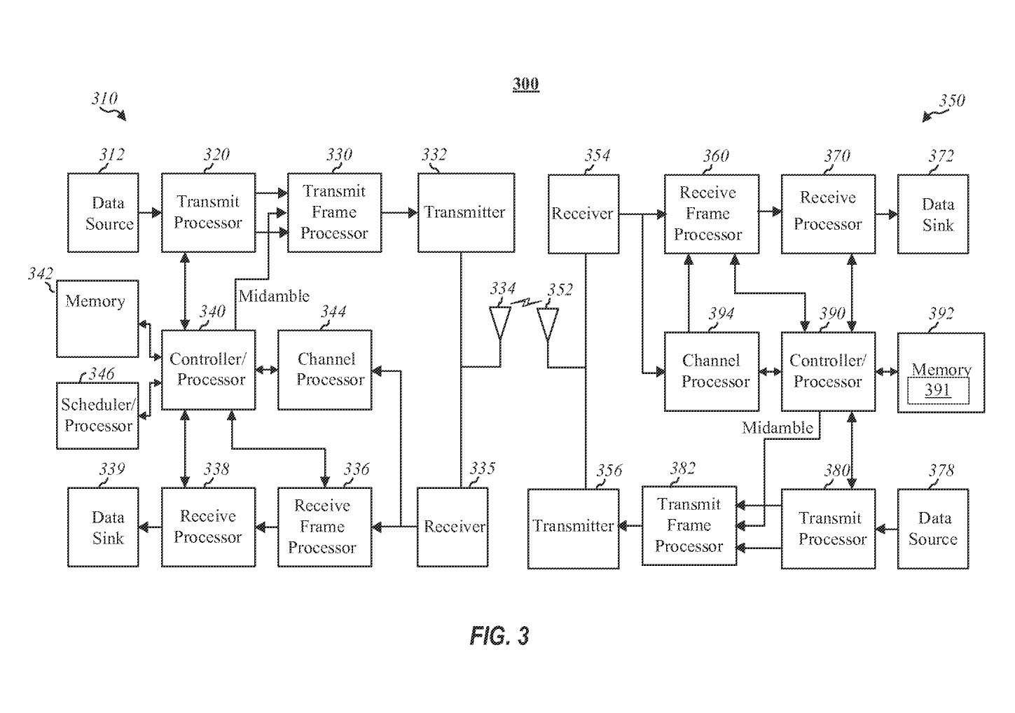

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store a stability control module 391 which, when executed by the controller/processor 390, configures the UE as indicated below. A scheduler/processor 346 at the node B 310 may be used to allocate resources to the UEs and schedule downlink and/or uplink transmissions for the UEs.

In a communication system that performs signal estimation and detection, a signal is often processed with certain filtering calculations. Different signal processing methods may generate filter weights for those calculations. Efficient filtering weight generation often involves scalar or matrix inversion. For example, in a linear minimum mean square error (MMSE) receiver in multiple input multiple output (MIMO) mode, which involves multiple receiving and transmitting antennas, as well as in an estimator with knowledge of orthogonal codes used in carrying signals, the weight generation often involves inversion of a matrix that may or may not be well conditioned. Inverting an ill conditioned matrix may cause stability issues with the filtering system, and may result in undesired receiver performance. The stability control in such a system often involves conditioning of the matrix to be inverted.

The condition number of a matrix is mathematically defined as a ratio between maximum and minimum Eigen values of a matrix. When the matrix dimension is larger than 2, obtaining these Eigen values often involves decomposition of matrices, which can be computationally complex and is thus undesirable in a practical system. Offered is a method to stabilize a receiving system by conditioning a matrix prior to inversion. The method uses the signal structures in common communication systems that modulate orthogonal codes with information symbols.

A received signal vector (y), can be calculated as shown in Equation 1:

$$y = {\sum }_{i = 0}^{S - 1} ( {H}_{i} {C}_{i} {W}_{i} {G}_{i} {s}_{i} ) + n = {\sum }_{i = 0}^{S - 1} {H}_{i} {x}_{i} + n \qquad Equation 1$$

In Equation 1 S is the number of cells or the number of beamforming configurations. Each cell or beamforming configuration has a propagation channel impulse response matrix, H. H may be represented as:

$${H}_{i} = {[ \begin{matrix}{h}_{i , 0} & 0 & 0 & 0 \\ {h}_{i , 1} & {h}_{i , 0} & 0 & 0 \\ ⋮ & {h}_{i , 1} & ⋱ & 0 \\ {h}_{1 , L - 1} & ⋮ & ⋱ & {h}_{i , 0} \\ 0 & {h}_{i , L - 1} & ⋮ & {h}_{i , 1} \\ ⋮ & ⋮ & {h}_{i , L - 1} & ⋮ \\ 0 & 0 & 0 & {h}_{i , L - 1}\end{matrix} ]}_{( NQ + L - 1 ) \times NQ}$$

where N is the data block length that is detected as one entity, in units of symbol duration of Q chips, where Q is the spreading factor. L is the multipath delay spread in number of chips. In a MIMO system, H is a concatenation of impulse responses of all transmit and receive antennas.

Referring again to Equation 1, C is a diagonal unitary matrix of the signal scrambling code. C may be represented as:

$${C}_{i} = [ \begin{matrix}{c}_{i , 0} & 0 & 0 & 0 \\ 0 & {c}_{i , 1} & 0 & 0 \\ 0 & 0 & ⋱ & 0 \\ 0 & 0 & 0 & {c}_{i , NQ - 1}\end{matrix} ]$$

W is an orthogonal unitary matrix for error correction. W=I_{N} [symbol] W_{Q} where [symbol] stands for the Kronecker product. For TD-SCDMA, W is a normalized Hadamard/Walsh matrix and may be expressed as:

$${W}_{Q} = [ \begin{matrix}{w}_{1 , 1} & {w}_{2 , 1} & {w}_{Q , 1} \\ {w}_{1 , 2} & {w}_{2 , 2} & {w}_{Q , 1} \\ ⋮ & & \\ {w}_{1 , Q} & {w}_{2 , Q} & {w}_{Q , Q}\end{matrix} ] = [ \begin{matrix}{w}_{1} & {w}_{2} & … & {w}_{Q}\end{matrix} ]$$

In Equation 1, s is the information symbols representing the transmitted signal on each code. Its elements are independent, identically distributed (i.i.d.). The signal s may be expressed as:

sᵢ=[s_{i,0}^{T}, s_{i,1}^{T}, . . . , s_{i,N}^{T} i=0,1, . . . , S-1

each symbol duration may carry Q symbols:

s_{i,j}=[s_{i,j,0}, s_{i,j,1}, . . . , s_{i,j,Q-1}]^{T} j=0,1, . . . , N-1

with E[sᵢsⱼ^{H}]=δ_{i,j}I_{NQ} for i, j=0,1, . . . , S-1

G is a diagonal matrix of code gain levels of each element of In TD-SCDMA, G is a 16×16 diagonal matrix showing the gain (g) on each of the 16 codes. G may be expressed as:

$${G}_{i , Q} = ( \begin{matrix}{g}_{i , 0} & & 0 \\ & ⋱ & \\ 0 & & {g}_{i , Q - 1}\end{matrix} )$$

In Equation 1 n is the noise vector. In one aspect, n is assumed complex Gaussian with all samples independent, identically distributed. The noise n may be expressed as:

n˜CN(0,σ_{w}²I)

In Equation 1 x is the signal after spreading and may be expressed as:

xᵢ=[x_{i,0}, x_{i,1}, . . . , x_{i,N-1}]^{T}, i=0,1, . . . S-1

x_{i,j}=[x_{i,j,0}, x_{i,j,1}, . . . , x_{i,j,Q-1}]^{T}j=0,1, . . . , N−1

The summation in Equation 1 is over all received signals in a structure. Each structure can be one cell in a cellular system, or a stream in a MIMO configuration.

Code conditioning a signal matrix prior to inversion may assist with stabilizing a receiving system. In several communication systems, such code conditioning may be computationally and resource intensive. In a TD-SCDMA system, however, the computational burden may be lessened due to the signal code structure/Walsh codes being included in the signal received by the MMSE receiver, whereas such codes may otherwise be averaged out in other systems. As described herein, code power information may be used to perform code conditioning prior to inversion to improve stability. Such code conditioning techniques may be particularly valuable in a TD-SCDMA system.

For conditioning, the matrix R is inverted by the linear MMSE receiver. The matrix

R is defined according to Equation 2:

$$\begin{matrix}{R}_{yy} = {E [ {yy}^{H} ]}_{( NQ + L - 1 ) \times ( NQ + L - 1 )} \\ = {\sum }_{i = 0}^{S - 1} {H}_{i} {C}_{i} {WG}^{2} {W}^{H} {C}_{i}^{H} {H}_{i}^{H} + {σ}_{w}^{2} {I}_{NQ + L - 1} \\ = {\sum }_{i = 0}^{S - 1} {H}_{i} {C}_{i} [ {I}_{N} ⊗ ( {W}_{Q} {G}_{Q}^{2} {W}_{Q}^{H} ) ] {C}_{i}^{H} {H}_{i}^{H} + {σ}_{w}^{2} {I}_{NQ + L - 1}\end{matrix} \qquad Equation 2$$

where I is an identity matrix, σ_{w}² is a noise variance, Cᵢ is a diagonal matrix, and Cᵢ^{H} is a conjugate transpose of Cᵢ. Because W is a unitary matrix and Cᵢ is a diagonal matrix, the Eigen values of CᵢWG²Cᵢ^{H} are diagonals of G², which is the code power. When channel impulse responses are single path, H is reduced to an identity matrix, and the code powers become the exact Eigen values of each entry in the summation HᵢCᵢWG²W^{II}Cᵢ^{II}Hᵢ^{II}. The Eigen values of the sum of matrices are upper bounded by the sum of the maximum Eigen values of each individual matrix, and lower bounded by the sum of the minimum Eigen values of each individual matrix.

Matrix conditioning may be performed as follows: first code domain conditioning occurs, then time domain conditioning is performed.

For code domain conditioning, code power levels of each cell are calculated. In one aspect, the code power information may be estimated through a fast Hadamard transform (FHT). In another aspect, the code power information may be estimated using the relationships between the code power vector and the signal midamble, this latter method being particularly helpful in a TD-SCDMA system.

Following the calculation of the code power level, a weighted summation of the maximum and minimum of the code powers of all cells is calculated. The weights may vary from no weighting, where the largest and minimum code power levels of all cells are added together with equal weight, to extreme weighting where only the largest maximum code power and smallest minimum code power are selected. Intermediate weighting schemes are also possible. The maximum Eigen value λ_{MAX} and minimum Eigen value λ_{MIN} of the received signal are obtained with such weighted summation.

To condition the matrix R and make it easier to process, the matrix R is first stabilized with a correction term. A small correction term A (where A is greater than or equal to zero) is added to the diagonal noise variance matrix R such that:

$$\frac{{λ}_{MAX} + {σ}_{w}^{2} + Δ}{{λ}_{MIN} + {σ}_{w}^{2} + Δ} < Code Condition Target \qquad Equation 3$$

In one aspect, Δ is chosen as the smallest value that satisfies Equation 3. The Code Condition Target is a target value chosen to condition the matrix in the code domain and improve processing. The matrix R is then inverted and receiver demodulation coefficients may be calculated based on the inverted matrix.

Effects of channel impulse response may be handled in the time domain. To perform time domain conditioning, the maximum (r_{MAX}) and minimum (r_{MIN}) diagonal elements of matrix R are found. To condition the matrix and make it easier to process, a small correction term Δ_{T} (where Δ_{T} is greater than or equal to zero) is added to the diagonal of R such that:

$$\frac{{r}_{MAX} + {Δ}_{T}}{{r}_{MIN} + {Δ}_{T}} < Time Condition Target \qquad Equation 4$$

In one aspect, Δ_{T} is chosen as the smallest value that satisfies Equation 4. The Time Condition Target is a target value chosen to condition the matrix in the time domain and improve processing. Time conditioning may be performed after code conditioning.

The matrix conditioning approaches discussed above reduce complexity and are more accurate and effective than classical processing techniques. Although the description is primarily with respect to MIMO and multiple cells, the present disclosure is equally applicable to any case with a large number of matrices.

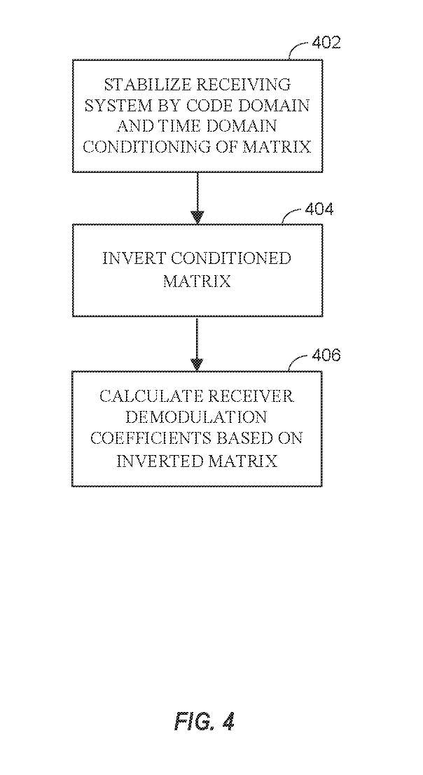

As shown in FIG. 4 a UE may stabilize a receiving system by conditioning a matrix prior to inversion by code domain conditioning the matrix and time domain conditioning the matrix, as shown in block 402. The UE may invert the conditioned matrix, as shown in block 404. The UE may calculate receiver demodulation coefficients based on the inverted matrix, as shown in block 406.

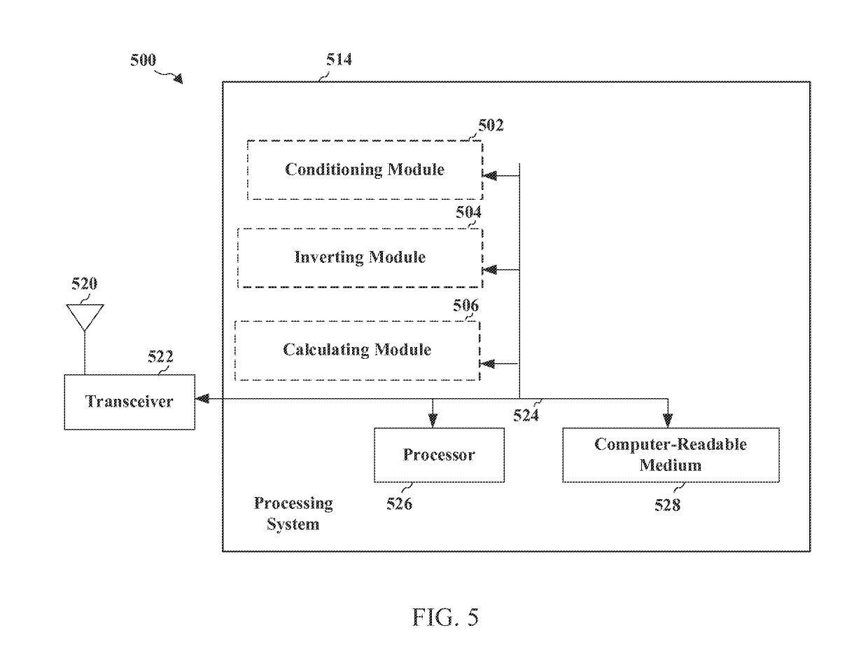

FIG. 5 is a diagram illustrating an example of a hardware implementation for an apparatus 500 employing a stability control system 514. The stability control system 514 may be implemented with a bus architecture, represented generally by a bus 524. The bus 524 may include any number of interconnecting buses and bridges depending on the specific application of the stability control system 514 and the overall design constraints. The bus 524 links together various circuits including one or more processors and/or hardware modules, represented by a processor 526, a conditioning module 502, an inverting module 504, a calculating module 506, and a computer-readable medium 528. The bus 524 may also link various other circuits such as timing sources, peripherals, voltage regulators, and power management circuits, which are well known in the art, and therefore, will not be described any further.

The apparatus includes the stability control system 514 coupled to a transceiver 522. The transceiver 522 is coupled to one or more antennas 520. The transceiver 522 provides a means for communicating with various other apparatus over a transmission medium. The stability control system 514 includes the processor 526 coupled to the computer-readable medium 528. The processor 526 is responsible for general processing, including the execution of software stored on the computer-readable medium 528. The software, when executed by the processor 526, causes the stability control system 514 to perform the various functions described supra for any particular apparatus. The computer-readable medium 528 may also be used for storing data that is manipulated by the processor 526 when executing software.

The stability control system 514 further includes the conditioning module 502 for code domain and time domain conditioning of a matrix prior to inversion. The stability control system 514 further includes the inverting module 504 for inverting the conditioned matrix. The stability control system 514 further includes the calculating module 506 for calculating receiver demodulation coefficients based on the inverted matrix. The conditioning module 502, the inverting module 504 and the calculating module 506 may be software modules running in the processor 526, resident/stored in the computer readable medium 528, one or more hardware modules coupled to the processor 526, or some combination thereof. The stability control system 514 may be a component of the UE 350 and may include the memory 392 and/or the controller/processor 390.

In one configuration, the apparatus 500 for wireless communication includes means for stabilizing, means for inverting, and means for calculating. The means may be the conditioning module 502, inverting module 504, calculating module 506, the stability control module 391, the memory 392, the controller/processor 390 and/or the stability control system 514 of the apparatus 500 configured to perform the functions recited by the measuring and recording means. In another aspect, the aforementioned means may be any module or any apparatus configured to perform the functions recited by the aforementioned means.

Several aspects of a telecommunications system has been presented with reference to TD-SCDMA systems. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
stabilizing a receiving system by conditioning a matrix prior to inversion by
code domain conditioning the matrix; and
time domain conditioning the matrix;
inverting the conditioned matrix; and
calculating receiver demodulation coefficients based on the inverted matrix.

2. The method of claim 1, in which code domain conditioning comprises:
calculating a code power level vector over all cells or streams;
using weighted summation of code power level vectors over all cells or streams to obtain a maximum value and a minimum value that represent a maximum and minimum Eigen values of a covariance matrix comprised of all the cells or streams;
generating a first minimum non-negative correction term based on the obtained maximum value and minimum value such that a ratio of maximum plus noise variance plus the first correction term and minimum plus noise variance plus correction term is less than a code threshold value; and
applying the correction term to a diagonal of the matrix to be conditioned.

3. The method of claim 2, in which calculating the code power level vector is based at least in part on despreading a received signal with all code sequences and calculating an average power of each of the code sequences.

4. The method of claim 2, in which calculating the code power level vector is based at least in part on a relationship between a midamble shift power and a corresponding code power in a Time Division-Synchronous Code Division Multiple Access (TD-SCDMA) system.

5. The method of claim 2, in which the weighting comprises:
equal weighting over all cells or streams,
unequal weighting of the cells or streams, and/or
selecting a maximum over all cells or streams to obtain a maximum and selecting a minimum of all cells or streams to obtain a minimum.

6. The method of claim 1, in which the time domain conditioning comprises:
finding a maximum and minimum of diagonal elements of a covariance matrix after code conditioning; and
generating a second minimum non-negative correction term based on the obtained maximum and minimum of diagonal elements such that a ratio of maximum plus the second correction term and minimum plus the second correction term is less than a time threshold value.

7. An apparatus for wireless communications, comprising:
means for stabilizing a receiving system by conditioning a matrix prior to inversion by
code domain conditioning the matrix; and
time domain conditioning the matrix;
means for inverting the conditioned matrix; and
means for calculating receiver demodulation coefficients based on the inverted matrix.

8. The apparatus of claim 7, in which the stabilizing means by code domain conditioning comprises:
means for calculating a code power level vector over all cells or streams;
means for using weighted summation of code power level vectors over all cells or streams to obtain a maximum value and a minimum value that represent a maximum and minimum Eigen values of a covariance matrix comprised of all the cells or streams;
means for generating a first minimum non-negative correction term based on the obtained maximum value and minimum value such that a ratio of maximum plus noise variance plus the first correction term and minimum plus noise variance plus correction term is less than a code threshold value; and
means for applying the correction term to a diagonal of the matrix to be conditioned.

9. The apparatus of claim 8, further comprising means for weighting by:
equally weighting over all cells or streams,
unequally weighting the cells or streams, and/or
selecting a maximum over all cells or streams to obtain a maximum and selects a minimum of all cells or streams to obtain a minimum.

10. The apparatus of claim 7, in which the stabilizing means by time domain conditioning comprises:
means for finding a maximum and minimum of diagonal elements of a covariance matrix after code conditioning; and
means for generating a second minimum non-negative correction term based on the obtained maximum and minimum of diagonal elements such that a ratio of maximum plus the second correction term and minimum plus the second correction term is less than a time threshold value.

11. A computer program product for wireless communications, the computer program product comprising:
a non-transitory computer-readable medium having program code recorded thereon, the program code comprising:
program code to stabilize a receiving system by conditioning a matrix prior to inversion by
code domain conditioning the matrix; and
time domain conditioning the matrix;
program code to invert the conditioned matrix; and
program code to calculate receiver demodulation coefficients based on the inverted matrix.

12. The computer program product of claim 11, in which the program code to stabilize by code domain conditioning comprises:
program code to calculate a code power level vector over all cells or streams;
program code to use weighted summation of code power level vectors over all cells or streams to obtain a maximum value and a minimum value that represent a maximum and minimum Eigen values of a covariance matrix comprised of all the cells or streams;
program code to generate a first minimum non-negative correction term based on the obtained maximum value and minimum value such that a ratio of maximum plus noise variance plus the first correction term and minimum plus noise variance plus correction term is less than a code threshold value; and
program code to apply the correction term to a diagonal of the matrix to be conditioned.

13. The computer program product of claim 12, further comprising program code to weight by:
equally weighting over all cells or streams,
unequally weighting the cells or streams, and/or
selecting a maximum over all cells or streams to obtain a maximum and selecting a minimum of all cells or streams to obtain a minimum.

14. The computer program product of claim 11, in which the program code to stabilize by time domain conditioning comprises:
program code to find a maximum and minimum of diagonal elements of a covariance matrix after code conditioning; and
program code to generate a second minimum non-negative correction term based on the obtained maximum and minimum of diagonal elements such that a ratio of maximum plus the second correction term and minimum plus the second correction term is less than a time threshold value.

15. An apparatus for wireless communication, comprising:
a memory; and
at least one processor coupled to the memory, the at least one processor being configured:
to stabilize a receiving system by conditioning a matrix prior to inversion by
code domain conditioning the matrix; and
time domain conditioning the matrix;
to invert the conditioned matrix; and
to calculate receiver demodulation coefficients based on the inverted matrix.

16. The apparatus of claim 15, in which the at least one processor is further configured to stabilize with code domain conditioning by:
calculating a code power level vector over all cells or streams;
using weighted summation of code power level vectors over all cells or streams to obtain a maximum value and a minimum value that represent a maximum and minimum Eigen values of a covariance matrix comprised of all the cells or streams;
generating a first minimum non-negative correction term based on the obtained maximum value and minimum value such that a ratio of maximum plus noise variance plus the first correction term and minimum plus noise variance plus correction term is less than a code threshold value; and
applying the correction term to a diagonal of the matrix to be conditioned.

17. The apparatus of claim 16, in which the at least one processor is further configured to calculate the code power level vector based at least in part on despreading a received signal with all code sequences and calculating an average power of each of the code sequences.

18. The apparatus of claim 16, in which the at least one processor is further configured to calculate the code power level vector based at least in part on a relationship between a midamble shift power and a corresponding code power in a Time Division-Synchronous Code Division Multiple Access (TD-SCDMA) system.

19. The apparatus of claim 16, in which the at least one processor is further configured to weight by:
equally weighting over all cells or streams,
unequally weighting of the cells or streams, and/or
selecting a maximum over all cells or streams to obtain a maximum and selecting a minimum of all cells or streams to obtain a minimum.

20. The apparatus of claim 15, in which the at least one processor is further configured to stabilize with the time domain conditioning by:
finding a maximum and minimum of diagonal elements of a covariance matrix after code conditioning; and
generate a second minimum non-negative correction term based on the obtained maximum and minimum of diagonal elements such that a ratio of maximum plus the second correction term and minimum plus the second correction term is less than a time threshold value.
